(19) United States
(12) Patent Application Publication
(10) Pub. No.: US 2024/0211592 A1
(43) Pub. Date: Jun. 27, 2024

(54) ASSESSING SECURITY IN INFORMATION AND EVENT MANAGEMENT (SIEM) ENVIRONMENTS

(71) Applicant: International Business Machines Corporation, Armonk, NY (US)

(72) Inventors: Marina Milazzo, Sugar Hill, GA (US); Mauricio Zamora Peralta, Naranjo (CR); STEPHEN KYLE TIBBETTS, Rockmart, GA (US); ERIC Daniel HANRATTY, San Jose (CR); Alex Chaves Malaver, San Jose (CR); JASON HARTLEY, Atlanta, GA (US); James F. McGarry, HADDONFIELD, GA (US); Mahbod Tavallaee, Arlington, MA (US); Jose Arturo Maroto Picado, San Jose (CR); Marvin Andres Valerio Gonzalez, San Jose (CR); David Michael McGinnis, Roswell, GA (US)

(21) Appl. No.: 18/088,565

(22) Filed: Dec. 24, 2022

(51) Int. Cl. G06F 21/55

(52) U.S. Cl. CPC G06F 21/554; G06F 2221/033

(57) ABSTRACT

An approach is disclosed for assessing effectiveness of security information and event management (SIEM) environments. A rule status information with a number of used rules and a number of unused rules and a log source status with a number of active log sources and a number of inactive log sources is received from a threat detection insight (TDI) component by a production SIEM environment assessment report (SPEAR) tool. TDI performance scores and TDI quality scores are received from the TDI component for each used rule by the SPEAR tool. The SPEAR tool determines an availability score, a performance score, and a quality score from the rule status information, the log source status information, the TDI performance scores, and the TDI quality scores. The SPEAR tool determines a SPEAR from the availability score, the performance score, and the quality score.

### BACKGROUND

The present invention relates to data security, and more specifically, to assessing security in information and event management environments.

### SUMMARY

According to an embodiment of the present invention, there is a method for assessing effectiveness of security information and event management (SIEM) environments. A rule status information is received from a threat detection insights (TDI) component by a SIEM production effectiveness assessment report (SPEAR) tool where the rule status information includes a number of used rules and a number of unused rules. A log source status information is received from the TDI component by the SPEAR tool where the log source status includes a number of active log sources and a number of inactive log sources. TDI performance scores are received from the TDI component for each used rule by the SPEAR tool. TDI quality scores are received from the TDI component for the each used rule by the SPEAR tool. The SPEAR tool determines an availability score, a performance score, and a quality score from the rule status information, the log source status information, the TDI performance scores, and the TDI quality scores. The SPEAR tool determines an assessment of the SIEM environment from the availability score, the performance score, and the quality score.

According to one embodiment of the invention, there is provided an information handling system including at least one processor and a local storage device accessible by the processor executing instructions implementing steps of the method for assessing effectiveness of security in SIEM environments.

According to one embodiment of the invention, there is provided a computing program product executing instructions on at least one processor including a local storage device accessible by the processor having the steps of the method for assessing security in information and event management (SIEM) environments.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will be apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a schematic system overview of producing SIEM Production Effectiveness Assessment Report (SPEAR);

FIG. 2 depicts a system view and flow of determining SPEAR;

FIG. 3 depicts a high level flow of determining SPEAR;

FIG. 4 depicts a schematic view of determining availability assessment;

FIG. 5 depicts a schematic view of determining performance assessment;

FIG. 6 depicts a schematic view of determining quality assessment;

FIG. 7 depicts an example SPEAR Clients with scoring ranges; and

FIG. 8 depicts a schematic view of a processing system wherein the methods of this invention may be implemented.

### DETAILED DESCRIPTION

Security information and event management (SIEM) is a field within the field of computer security, where software products and services combine security information management and security event management. They provide real-time analysis of security alerts generated by applications and network hardware. SIEM combines both security information management (SIM) and security event management (SEM) into one security management system. SIEM technology collects event log data from a range of sources, identifies activity that deviates from the norm with real-time analysis, and takes appropriate action. The ubiquity of modem day computing apparatus and their connectedness to one or more networks and to the Internet can render the computing apparatus, networks, data stored and programs operated thereby vulnerable to attack by malicious agents, known as “hackers,” trying to gain access to and control of the resources made available by these connected computing environments. Attempts at malicious attacks on a computer system or network, known as “cyber threats,” can take the form of many different attack vectors. Successful attacks can compromise a computer system in various ways, such as, confidentiality, system integrity, resource availability, and the like. Common attack vectors for achieving access to or control of resources of a computer system include malware such as malicious libraries, viruses, worms, Trojans, malicious active content, denial of service attacks, operating system (OS) command injection attacks, buffer overflow attacks, cross-site scripting attacks (XSS), phishing attacks, SQL injection attacks (SQLI), and etc. All of these attacks operate by exploiting weaknesses in the security of specific computer systems. Cyber threats generally are increasing in their frequency with a typical organization trying to operate a secure computer system now facing a multitude of threats within the cyber sphere. Specific computing environments made available securely over a network will attract specific threat sources and actors with attack vectors that are continually evolving and becoming more sophisticated. Further, specific secure computing environments have different security weaknesses whether or not they are easily discoverable. Different computing environments may be susceptible to being compromised by different kinds and variants of cyber-attack vectors. Cyber threats are now wide ranging in their origin, arising from hostile foreign intelligence services, terrorists, hackers, and etc.

Conventional security products often detect issues too slowly and provide a fragmented and incomplete view into what's happening within a network. The goal of Threat detection insights (TDI) is to block most malicious web and email traffic, confirm zero-day attacks, create real-time threat intelligence, and capture dynamic callback destinations. The TDI component generates alerts. The alerts are investigated, triaged, and inline blocking is deployed at critical locations within the supported network.

While there are existing systems that strive to improve the effectiveness of production SIEM environments, there do not appear to be ways to easily assess the SIEM environments themselves. The current data collection and presentation for effectiveness in a production SIEM environment is not central or easily accessible to allow for a quick and high visibility overview of possible improvements.

In order to improve on the deficiencies of current evaluations of production SIEM environments, embodiments of the disclosed invention provide an approach to evaluate an effectiveness of a SIEM environment. The approach provides a clear articulation of the value and effectiveness of the SIEM environment and security service. The evaluation helps system administrators to identify weak areas in different segments of the security implementation and to identify areas for future improvements. SIEM environment status and TDI data are leveraged to provide a mathematical representation of the SIEM environment with respect to number of enabled rules, log sources, performance, and quality. These factors are extracted from the SIEM environment and from the TDI data to create a standardized report in which all results are derived from the same data and data source. This makes the results consistent and reliable.

SIEM Production Effectiveness Assessment Report (SPEAR) is designed to show the value easily and clearly, or effectiveness of a SIEM product in the client's digital environment. This is achieved by setting specific standards in the client environment, leveraging a tool to consolidate the data, and then absorbing the data into the SPEAR tool for presentation of effectiveness.

SIEM tools centralize, correlate, and analyze data across the information technology (IT) network to detect security issues. Core functionality of a SIEM includes log management, centralization, security event detection, reporting, and search capabilities. This combination helps companies meet compliance needs and identify and contain attackers faster. A modern SIEM needs three core capabilities: (1) Data collection. (2) Analytics. and (3) Response. These core capabilities facilitate the security monitoring and visibility needed in today's hybrid and multi-cloud environments. A SIEM's job is to ingest data across an entire network (data collection), identify malicious behavior (analytics), and provide alerts to security and IT teams. The visibility and information allow IT teams to respond before an issue becomes serious (response). If compliance reporting is an important driver, a SIEM should also be able to assist with dashboards and ensuring security policy is being enforced.

In an embodiment, the SIEM environment has the rules tagged using MITRE®¹ Adversarial Tactics, Techniques, and Common Knowledge (ATT&CK™) framework. The support may be integrated into a product accessed from the SIEM environment, such as, but not limited to QRadar® Advisor with Watson™ which leverages Artificial Intelligence (AI) to quickly determine the cause and scope of security threats. The components including SIEM, TDI, QRadar, SPEAR tool may support and use application programming interfaces (APIs) to communicate with each other. For example, TDI may access the SIEM environment via APIs and information may be sent from the SIEM environment to the TDI by APIs. MITRE ATT&CK provides a framework for security managers to assess and improve their security controls for industrial control systems (ICS) and operational technology (OT) environments. ATT&CK is a knowledge base of adversary tactics and techniques. These techniques are indexed and break down into detail the exact steps and methods that hackers use, making it easy for teams to understand the actions that may be used against a particular platform. To go a step further, MITRE also incorporates cyber-threat intelligence documenting adversary group behavior profiles to document which attack groups use which techniques. The ATT&CK matrix structure is similar to a periodic table, with column headers outlining phase in the attack chain (from initial access all the way to impact). The rows below them detail specific techniques. Framework users can further explore any of the techniques to learn more about the tactics, platforms exploited, example procedures, mitigation, and detections. A growing body of evidence from industry, MITRE, and government experimentation confirms that collecting and filtering data based on knowledge of adversary tactics, techniques, and procedures (TTPs) is an effective method for detecting malicious activity. ¹MITRE and ATT&CK are trademarks of The MITRE Corporation QRadar Advisor and Watson are trademarks of INTERNATIONAL BUSINESS MACHINES CORPORATION.

In an embodiment, the data that is being sent to the SIEM environment and the TDI is processed in specific ways to provide the SPEAR tool with the following information: (1) Active Rules. (2) Passive Rules. (3) Disabled Rules. (4) Active Log Sources. (5) Inactive Log Sources. (6) Rule Performance. and (7) Rule Quality. A rule that is enabled and configured to generate offenses within a SIEM environment is identified as an active rule. A rule within the SIEM environment that is enabled but not configured to generate offenses is identified as a passive rule. A passive rule could be used for other purposes, such as, but not limited to searches, reports, nested in other rules, and etc. A rule within the SIEM environment that does not contribute to offenses or processing of any type of events is identified as a disabled. The active rules combined with the passive rules may also be identified as used rules. The disabled rules may also be identified as unused rules. The total number of rules in the SIEM environment is the number of used rules added to the number of unused rules. A log source that communicates with SIEM within the last predetermined period of time, for example, 12 hours is identified as an active log source. A log source that has not sent an event within the last predetermined period of time is identified as an inactive log source. A log source that is part of a log source database for the SIEM environment that is manually set to stop communicating with the SIEM environment is identified as a disabled log source.

In an embodiment, “availability” is guaranteed to be a number between 0 and 1 and is constructed by taking used (active and passive) rules divided by the total number of rules alongside active log sources divided by the used (active and Inactive) log sources. These two numbers are added together and then divided by 2 to give an equally weighted score of availability based on log sources and rules.

In an embodiment, “performance” is guaranteed to be a number between 0 and 1 and is based on the ability of the SIEM environment to process the events through the ruleset. This information may be provided directly to the TDI by a backend of the SIEM environment, such as QRadar. This information is added to the performance SPEAR formula of total score divided by total count of used (active plus passive) rules. In order to adjust the internal scoring, in a case where the performance value assigned by the TDI to a rule is between 0 and 10, then the final sum is divided by 10.

In an embodiment, “quality” is guaranteed to be a number between 0 and 1 and may be based on 8 scoring metrics within the TDI: 1) False positive. 2) True positive. 3) Duplicate rule. 4) Rule coverage. 5) MITRE TTP coverage, 6) Rule status. 7) Rule performance. 8) Rule changes. This information may be provided directly to the TDI by a backend of the SIEM environment, such as QRadar. The TDI scores each tagged rule. The SPEAR tool ingests this score and divides it by the total number of used (active and passive) rules to generate the overall quality score. In order to adjust for the internal scoring, in the case where the quality value assigned by the TDI to a rule is between 0 and 100, then the final sum is divided by 100. In other embodiments different scaling factors may be used and adjustments made as needed during the calculations.

The SPEAR tool takes the availability score, the performance score, and the quality score and determines the overall effectiveness of the SIEM environment by producing SPEAR. In an embodiment where combining the availability, performance and quality scores is guaranteed to be a number between 0 and 1, the value may be multiplied by 100 to indicate a percentage, that is, a number between 0 and 100. In an embodiment, the following scale may be used: 0-20=Bad. 21-30=Needs Improvement. 31-55=Good. 56-100=Excellent. These scores may be used to drive expert team presentations, reports, and recommendations to help the client increase overall effectiveness.

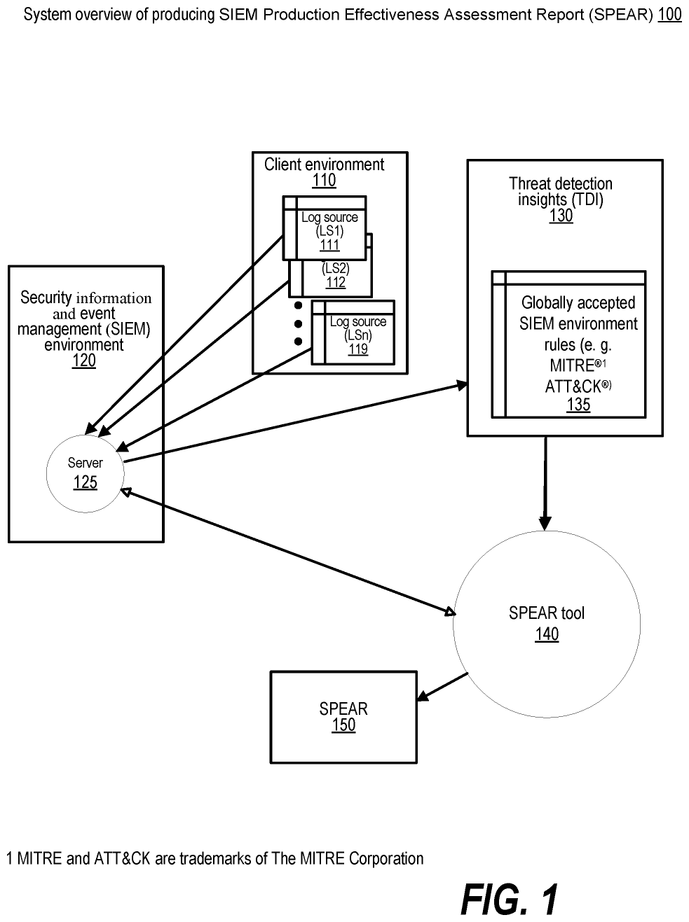

FIG. 1 depicts a schematic system overview of an embodiment for producing SIEM Production Effectiveness Assessment Report (SPEAR) 100. The client environment 110 which may include various machines and operating systems sends event logs from log sources to a security information and event management (SIEM) environment 120. The SIEM environment may contain various services, applications, and one or more servers. Although one or more servers may receive the event logs from client environment 110, for illustration purposes only, the event logs are shown in FIG. 1 to be received by server 125. Server 125 receives security event logs from client environment 110 from various sources, such as, LS (log source 1 (LS1) 111, log source 2 (LS2) 112, . . . , log source n (LSn) 119). The server 125 processes events in the event logs according to set of rules R (R1, R2, . . . , Rm) and tracks information about the processing of the events and usage of the rules R (R1, R2, . . . , Rm). The tracked information regarding the processing of the events and the usage of the rules R (R1, R2, Rm) is sent by server 125 to threat detection insights (TDI) 130 and to a SPEAR tool 140. The TDI 130 receives the information about the processing of the events and the usage of the rules R (R1, R2, . . . , Rm) and analyzes the processing against globally accepted SIEM environment rules (e. g. MITRE ATT&CK) 135 to determine for each rule Ri a TDI assigned performance score TPSi and a TDI assigned quality score TQSi which are sent to the SPEAR tool 140. The SPEAR tool 140 processes the input from the TDI 130 and the input from SIEM environment 120 and generates SPEAR 150.

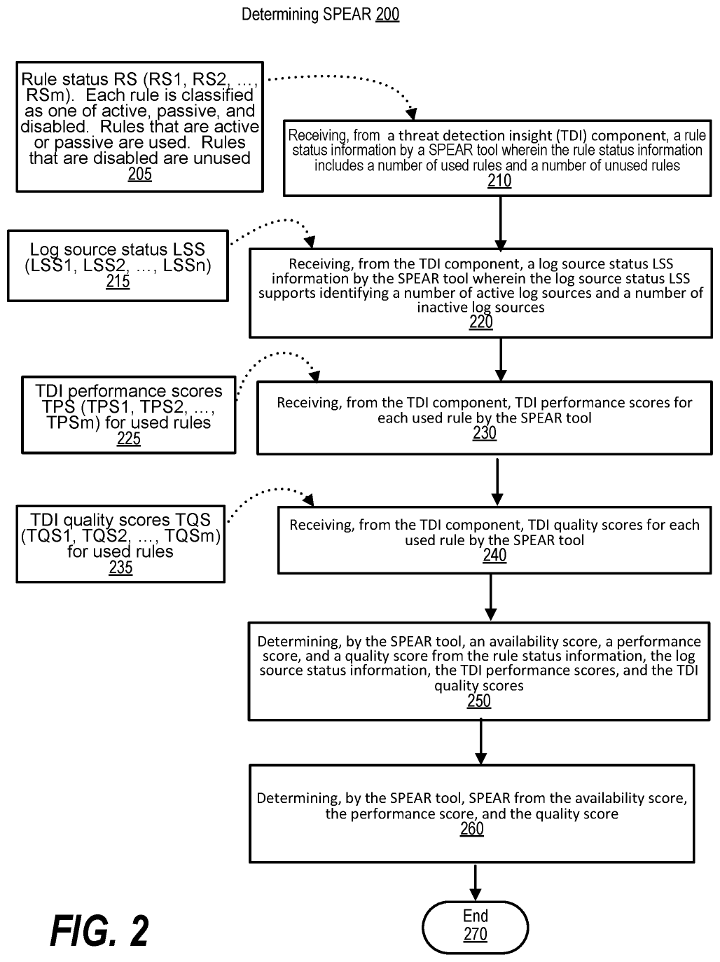

FIG. 2 shows the steps taken by a process that generates SPEAR 200. At step 210, the process receives, from the TDI 130, a rule status information 205 by the SPEAR tool 140. The rules R (R1, R2, . . . , Rm) in the SIEM environment 120 have a corresponding rule status RS (RS1, RS2, . . . , RSm). Each rule Ri has a corresponding rule status RSi wherein the rule status RSi is one of active, passive, and disabled. Those rules with the rule status of active or passive may be called used rules. Those rules with the rule status of disabled may be called not used rules or unused rules. Logs L (L1, L2, . . . , Lp) in the SIEM environment 120 may be received from various log sources LS (LS1, LS2, . . . , LSp) wherein each log Li is from log source LSi. Many logs may be received from the same source, that is, for example, log source LS1 may be the same as log source LS2. The logs may represent security events from different environments. The environments, may include, for example, but not limited to, Microsoft®² Windows® security event log, Linux® OS, IBM® AIX® Server, Cisco® Identify Server, and the like. At step 220, the process receives from the TDI 130, a log source status LSS (LSS1, LSS2, . . . , LSSq) 215 by the SPEAR tool 140 wherein the log source status LSS (LSS1, LSS2, . . . , LSSq) 215 may support identifying a total number of distinct log sources, that is, for example, q may be the total number of distinct log sources. At step 230, the process receives from the TDI 130, TDI performance scores for used rules TPS (TPS1, TPS2, . . . , TPSm) 225 by the SPEAR tool 140 for each rule used in the period of time. Alternatively, each log source status LSSi may identify information about the log Li, such as, for example, but not limited to, a type of log, a platform that generated the log, an indication that the log Li is active, inactive, or disabled, and the like. The status information typically represents the processing of events that are recorded in logs from log sources. Only used rules cause events, that is, active rules and passive rules cause events. Unused rules, which may be referenced as disabled rules are rules which have not been used in the period of time. At step 240, the process receives from the TDI 130, TDI quality scores TQS (TQS1, TQS2, . . . , TQSm) for used rules 235 by the SPEAR tool 140 for each rule used in the period of time. At step 250, the process determines, by the SPEAR tool 140, an availability score, a performance score, and a quality score from the rule status information, the log source status information, the TDI performance scores, and the TDI quality scores. At step 260, the process determines by the SPEAR tool 140, SPEAR from the availability score, the performance score, and the quality score. FIG. 2 processing thereafter ends at 270. ²MICROSOFT and Windows are trademarks of MICROSOFT CORPORATION LINUX is a trademark of Linus Torvalds. IBM and AIX are trademarks of INTERNATIONAL BUSINESS MACHINES CORPORATION. CISCO is a trademark of Credit Information Service Company, Inc

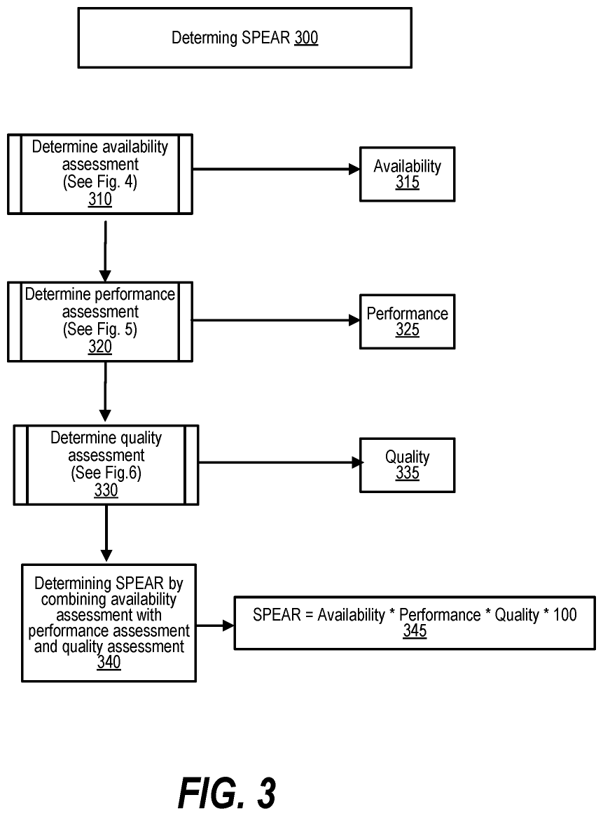

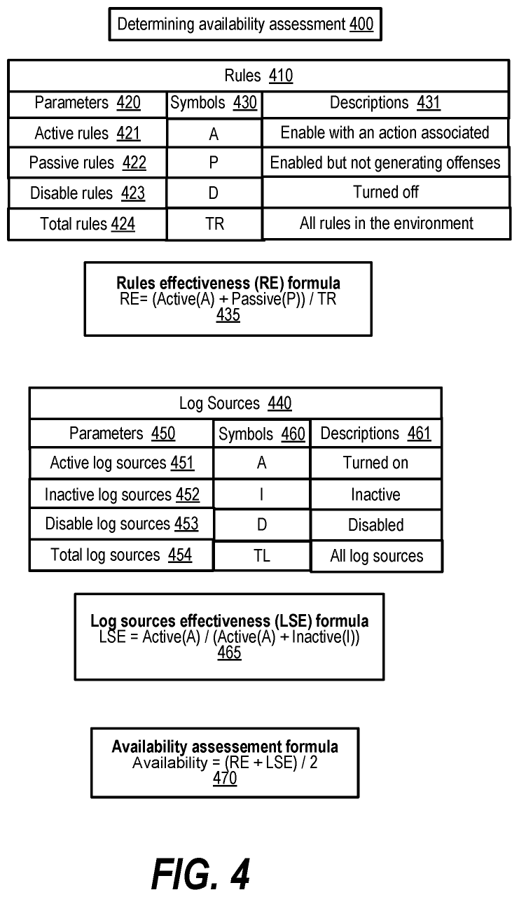

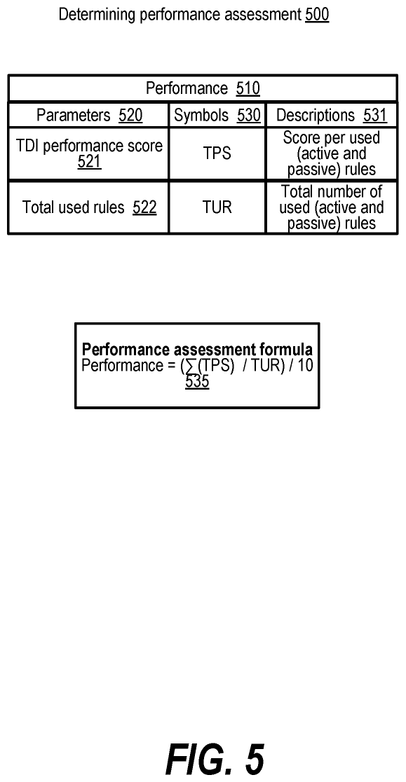

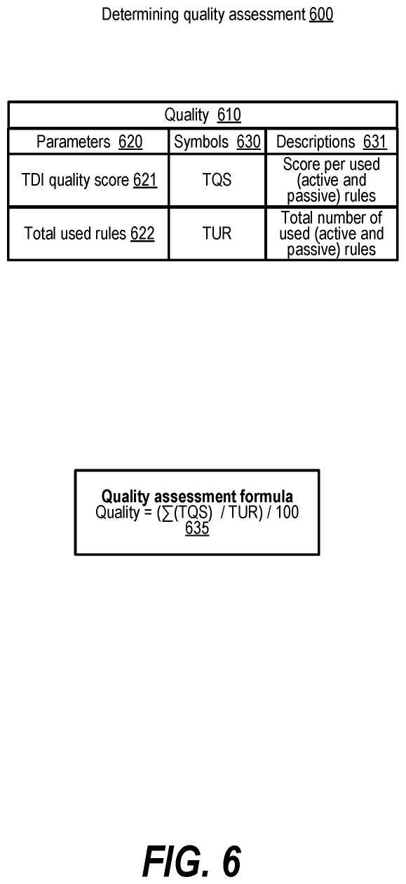

FIG. 3 shows the steps taken by a process that determines SPEAR 300. At predefined process 310, the process performs the determine availability assessment routine (see FIG. 4 and corresponding text for processing details) which returns availability 315. At predefined process 320, the process performs the determine performance assessment routine (see FIG. 5 and corresponding text for processing details) which returns performance 325. At predefined process 330, the process performs the determine quality assessment routine (see FIG. 6 and corresponding text for processing details) which returns quality 335. At step 340, the process determines SPEAR by combining availability assessment with performance assessment and quality assessment. At step 345, in an embodiment SPEAR=Availability*Performance*Quality*100.

FIG. 4 shows the steps taken by a process that determines availability assessment 400. 410 depicts a summary of rules status determined from the rule status information 205 in a SIEM environment 120. The summary of rules includes: (parameters 420, (symbols 430), and {descriptions 431}) with the parameters including (a number of active rules 421 (A) {enable with an action associated}), (a number of passive rules 422 (P) {enabled, but not generating offenses}), (a number of disabled rules 423, (D) {turned off}), and (a total number of rules 424 (TR) {all rules in SIEM environment}).

440 depicts a summary of log source status determined from client environment 110 and the log sources LS ((LS1) 111, (LS2) 112, . . . , LSn 119) sent to server 125. The summary of log sources 440 includes: (parameters 450, (symbols 460), and {descriptions 461} with the parameters including (a number of active log sources 451 (A) {turned on}), (a number of inactive log sources 452 (1) {inactive}), (a number of disabled log sources 453 (D) {disabled}), and (a total number of log sources 454 (TL), {all log sources}).

435 determines the rules effectiveness (RE) formula that determines RE by dividing the number of used rules by the total number of rules. The number of used rules sources is the number active log sources 451 added to the number of inactive log source 452. 465 determines the logs source effectiveness formula (LSE), where LSE is set to the number of active log sources divided by the number of used log sources. 470 determines the availability assessment formula which adds the rules effectiveness result (RE) 435 to the log source effectiveness result (LSE) 465 to form a sum and divides the sum by 2.

FIG. 5 shows the steps taken by a process that determines performance assessment 500. 510 depicts a summary of performance for used rules. Performance 510 includes (parameters 520 (symbols 530), and {descriptions 531}). The parameters include (TDI performance score 521 (TPS) {performance score per used rule}) and (total number of used rules 522 (TUR) {total used rules (active, passive)}.

535 depicts the performance assessment formula, where performance=(X(TPS)/TUR)/10. That is, the sum of the TDI assigned performance scores for each used rule is divided by the total number of used rules. The result of that division is divided by 10 since the TDI assigned performance value for each used rule is between 0 and 10.

FIG. 6 shows the steps taken by a process that determines quality assessment 600. 610 depicts a summary a quality for used rules. Quality 610 includes (parameters 620, (symbols 630), and {descriptions 631}). The parameters include: (TDI quality score 621 (TQS) {quality score per used rule}) and (total number of used rules 622 (TUR) {total used rules (active, passive)}).

635 depicts the quality assessment formula, where Quality=(Z(TQS)/TUR)/100. That is, the sum of the TDI assigned quality scores for each used rule is divided by the total number of used rules. The result of that division is divided by 100 since the TDI assigned quality value for each used rule is between 0 and 100.

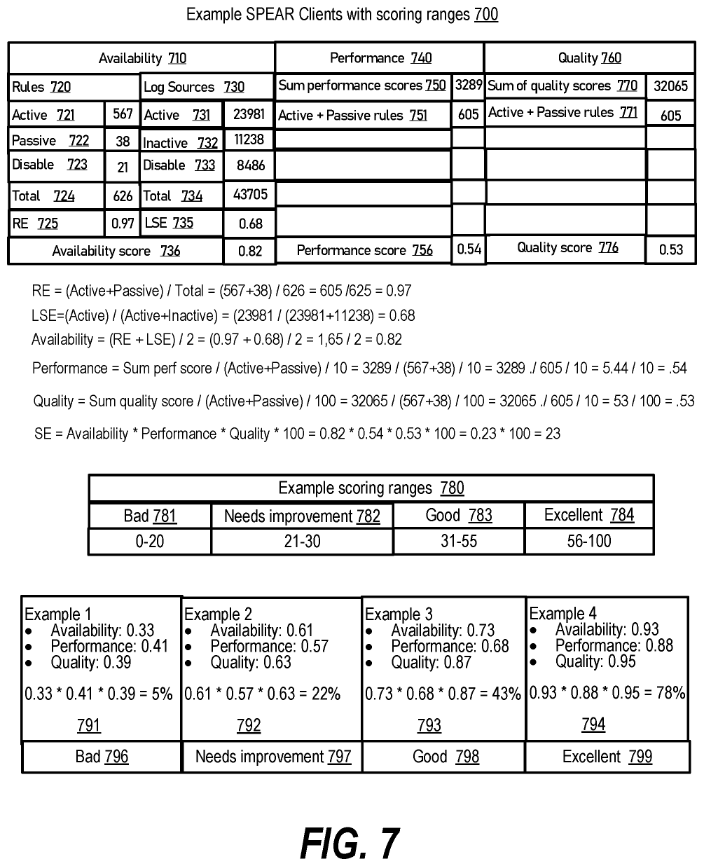

FIG. 7 depicts example SPEAR clients with scoring ranges 700. Availability 710 lists rules 720 and log sources 730. The example client has 567 active rules 721, 38 passive rules 722, and 21 disabled rules 723. The total used rules are the active rules 721 added to the passive rules 722 which equals 605. The 626 total number of rules 724 is equal to the number of used rules added to the number of unused rules or disabled rules 723. The example client has 23,981 active log sources 731, 11,238 inactive log sources 732, and 8486 disabled log source 733. The number of used log sources is the number of active added to the number of inactive which equals 35,219. The 43,705 total number 734 of log sources includes the 8,486 disabled log sources 733. The calculations for RE 725, LSE 735, and availability 736 are shown in FIG. 7. Performance 740 lists 3289 as the sum performance scores 750 and the 605 number of used rules (active+passive) 751. The calculations for performance 756 are shown in FIG. 7. Quality 760 lists 32,065 as the sum of the quality scores 770 and the 605 number of used rules (active+passive) 771 which are combined to form quality score 776. Calculations are shown in FIG. 7 for the performance assessment formula 535 and the quality assessment formula 635.

780 depicts example ranges of 0-20 bad 781, 21-30 needs improvement 782, 31-55 good 783, and 56-100 excellent 784. Examples 1-4 depict an embodiment where percentages are used to indicate multiplying by 100. 791 depicts example of bad 796 scores, 792 depicts an example of needs improvement 797, 793 depicts an example of good 798, and 794 depicts an example of excellent 799. The purpose of characterizing the ranges is to provide an easy to understand assessment of the SIEM environment. The assessment may be used for planning and funding, if needed, to improve SIEM processing and to verify outcomes of changes to the SIEM environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 800 contains an example of an environment for the execution of at least some of the computer code involved in performing the inventive methods, such as producing SIEM production effectiveness assessment report (SPEAR) 850. In addition to block 850, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 850, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

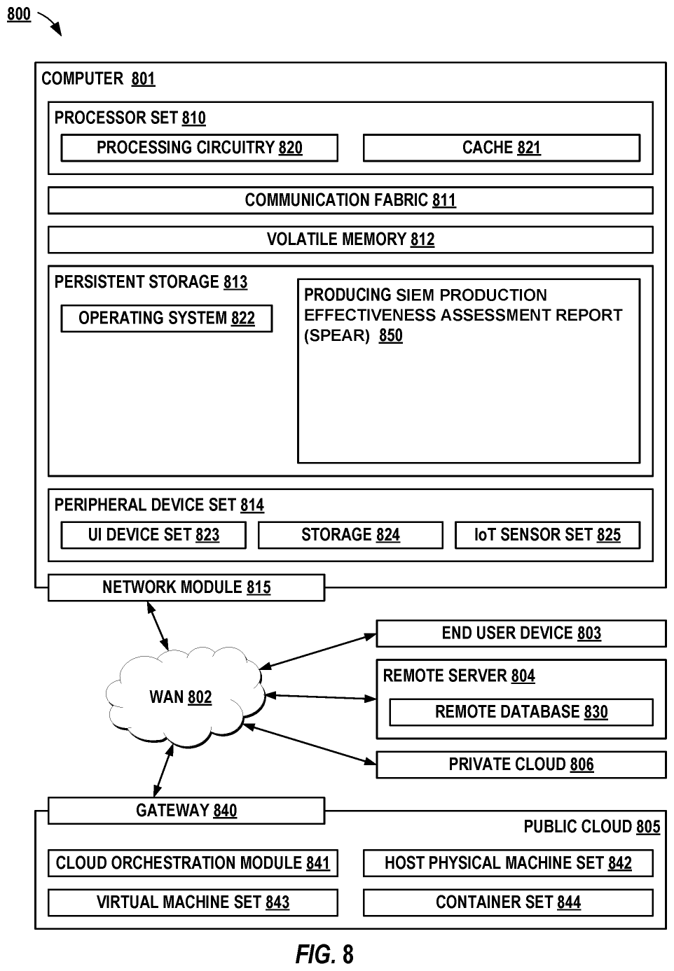

COMPUTER 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 850 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface-type operating systems that employ a kernel. The code included in block 850 typically includes at least some of the computer code involved in performing the inventive methods.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801) and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for assessing effectiveness of security information and event management (SIEM) environments comprising:
receiving, from a threat detection insight (TDI) component, a rule status information by a SIEM production effectiveness assessment report (SPEAR) tool wherein the rule status information includes a number of used rules and a number of unused rules;
receiving, from the TDI component, a log source status information by the SPEAR tool wherein the log source status includes a total number of log sources;
receiving, from the TDI component, TDI performance scores for each used rule by the SPEAR tool;
receiving, from the TDI component, TDI quality scores for the each used rule by the SPEAR tool;
determining, by the SPEAR tool, an availability score, a performance score, and a quality score from the rule status information, the log source status information, the TDI performance scores, and the TDI quality scores; and
determining, by the SPEAR tool, SPEAR from the availability score, the performance score, and the quality score.

2. The method of claim 1, wherein the rule status information includes a number of active rules, a number of passive rules, and a number of disabled rules and wherein the number of used rules is calculated by adding the number of active rules to the number of passive rules and wherein the number of unused rules is the number of disabled rules and wherein a total number of rules is calculated by adding the number of used rules to the number of unused rules.

3. The method of claim 1, wherein the SPEAR is a value.

4. The method of claim 3, wherein the value is between 0 and 100.

5. The method of claim 4, wherein the value is a product of the availability score, the performance score, and the quality score.

6. The method of claim 2, further comprising:
deriving the availability score from the number of used rules divided by the total number of rules.

7. The method of claim 6, further comprising:
deriving the quality score from a sum of the TDI quality scores divided by the total number of used rules.

8. The method of claim 6, further comprising:
deriving the performance score from a sum of the TDI performance scores divided by the number used rules.

9. The method of claim 3, wherein the SPEAR is broken into subranges of the value and wherein a first subrange of 0 to x is bad, a second subrange from x+1 to y is needs improvement, a third subrange from y+1 to z is good, and a fourth subrange from z+1 to 100 is excellent.

10. The method of claim 9, wherein the first subrange is 0 to 20, the second subrange is 21 to 30, the third subrange is 31 to 55, and the fourth subrange is 56 to 100.

11. An information handling system for assessing security information and event management (SIEM) environments comprising:
one or more processors;
a memory coupled to at least one of the processors;
a network interface that connects the local device to one or more remote web sites; and
a set of computer program instructions stored in the memory and executed by at least one of the processors in order to perform actions comprising:
receiving, from a threat detection insight (TDI) component, a rule status information by a SPEAR tool wherein the rule status information includes a number of used rules and a number of unused rules;
receiving, from the TDI component, a log source status information by the SPEAR tool wherein the log source status includes a total number of log sources;
receiving, from the TDI component, TDI performance scores for each used rule by the SPEAR tool;
receiving, from the TDI component, TDI quality scores for the each used rule by the SPEAR tool;
determining, by the SPEAR tool, an availability score, a performance score, and a quality score from the rule status information, the log source status information, the TDI performance scores, and the TDI quality scores; and
determining, by the SPEAR tool, SPEAR from the availability score, the performance score, and the quality score.

12. The information handling system of claim 11, wherein the rule status information includes a number of active rules, a number of passive rules, and a number of disabled rules and wherein the number of used rules is calculated by adding the number of active rules to the number of passive rules and wherein the number of unused rules is the number of disabled rules and wherein a total number of rules is calculated by adding the number of used rules to the number of unused rules.

13. The information handling system of claim 11, wherein the SPEAR is a value.

14. The information handling system of claim 13, wherein the value is between 0 and 100.

15. The information handling system of claim 14, wherein the value is a product of the availability score, the performance score, and the quality score.

16. A computer program product for assessing security information and event management (SIEM) environments comprising stored in a computer readable storage medium, comprising computer program code that, when executed by the computer program product, performs actions comprising:
receiving, from a threat detection insight (TDI) component, a rule status information by a SPEAR tool wherein the rule status information includes a number of used rules and a number of unused rules;
receiving, from the TDI component, a log source status information by the SPEAR tool wherein the log source status includes a total number of log sources;
receiving, from The TDI component, TDI performance scores for each used rule by the SPEAR tool;
receiving, from the TDI component, TDI quality scores for the each used rule by the SPEAR tool;
determining, by the SPEAR tool, an availability score, a performance score, and a quality score from the rule status information, the log source status information, the TDI performance scores, and the TDI quality scores; and
determining, by the SPEAR tool, SPEAR from the availability score, the performance score, and the quality score.

17. The computer program product of claim 16, wherein the rule status information includes a number of active rules, a number of passive rules, and a number of disabled rules and wherein the number of used rules is calculated by adding the number of active rules to the number of passive rules and wherein the number of unused rules is the number of disabled rules and wherein a total number of rules is calculated by adding the number of used rules to the number of unused rules.

18. The computer program product of claim 17, wherein the SPEAR is a value.

19. The computer program product of claim 18, wherein the value is between 0 and 100.

20. The computer program product of claim 19, wherein the value is a product of the availability score, the performance score, and the quality score.
